(19) United States
(12) Patent Application Publication
(10) Pub. No.: US 2011/0243111 A1
(43) Pub. Date: Oct. 6, 2011

(54) Timing of Uplink Transmissions in a Multi-Carrier Communication System

(76) Inventors: Niklas Andgart, Sodra Sandby (SE); Christian Bergljung, Lund (SE); Matthias Kamuf, Lund (SE); Bengt Lindoff, Bjarred (SE); Anders Wallén, Ystad (SE)

(21) Appl. No.: 12/869,693

(22) Filed: Aug. 26, 2010

Related U.S. Application Data
(60) Provisional application No. 61/319,318, filed on Mar. 31, 2010.
(60) Provisional application No. 61/331,883, filed on May 6, 2010.

(51) Int. Cl. H04W 4/00

(52) U.S. Cl. 370/338

(57) ABSTRACT

A terminal with transmitter and receiver operates in a multi-carrier communication system and receives at least two downlink carriers. One or more timing advance commands are received, each associated with a group of one or more uplink carriers, each group being associated with one or more of the received downlink carriers. For each downlink carrier associated with one of the groups of uplink carriers, one is selected as a reference downlink carrier; the reference downlink carrier timing is ascertained; and a transmission time period is ascertained based on the timing of the downlink reference carrier and an offset specified by the timing advance command associated with the group of uplink carriers. The transmission time period comprises a start time and a stop time. Transmission is initiated at an earliest transmission start time of the ascertained transmission time periods and is ceased at a latest ascertained stop time.

### CROSS REFERENCE TO RELATED APPLICATIONS

This application claims the benefit of U.S. Provisional Application No. 61/319,318, filed Mar. 31, 2010, which is hereby incorporated herein by reference in its entirety. This application also claims the benefit of U.S. Provisional Application No. 61/331,883, filed May 6, 2010, which is hereby incorporated herein by reference in its entirety.

### BACKGROUND

The present invention relates to cellular communication systems, more particularly to multi-carrier communication systems, and even more particularly to the timing of uplink transmissions in a multi-carrier communication system. Cellular communication systems are well-known and are in wide-spread use around the world. FIG. 1 is a diagram illustrating a common feature found in most systems: a serving node 101 (depending on the system, it can be called a “base station”, a Node B, an evolved Node B (“eNodeB” or “eNB”)) serves user equipment (UE) 103 that is located within the serving node's geographical area of service, called a “cell” 105. For convenience, the term eNB will be used henceforth throughout this document, but any such references are not intended to limit the scope of the invention to only those particular systems that use this particular terminology. Thus, references to “eNB” are intended to also refer to “base stations”, “Node B′s”, and “eNodeB's” and also to any equivalent node in a cellular communication system.

Communication is bidirectional between the eNB 101 and the UE 103. Communications from the eNB 101 to the UE 103 are referred to as taking place in a “downlink” direction, whereas communications from the UE 103 to the eNB 101 are referred to as taking place in an “uplink” direction.

In forthcoming evolutions of cellular system standards like the Third Generation Partnership Project's (3GPP's) Long Term Evolution (“LTE”) the maximum data rate is sure to be higher than in existing systems. Higher data rates typically require larger system radio spectrum bandwidths. For the International Mobile Telecommunications-Advanced (“IMT-Advanced”) system (i.e., the fourth generation mobile communication systems) bandwidths up to 100 MHz are being discussed. A problem being faced is that the radio spectrum is a limited resource that has to be shared by many operators and systems; this makes it very complicated to find 100 MHz of free contiguous spectrum that can be allocated.

One method of overcoming this problem is aggregating contiguous and non-contiguous spectrum and thereby—from a baseband point of view—making a large system bandwidth. This is illustrated in FIG. 2, which shows an aggregation of two 20 MHz bands 201, 203 and one 10 MHz band 205. The 20 MHz band 203 and the 10 MHz band 205 are contiguous, whereas the 20 MHz band 201 is separated from the 20 MHz and 10 MHz bands 203, 205 by some amount of spectrum 207. The benefit of such a solution is that it becomes possible to generate sufficiently large bandwidths (e.g., 50 MHz in the example of FIG. 2) for supporting data rates up to (and above) 1 Gb/s, which is a throughput requirement for a fourth generation (“4G” or IMT-advanced) system. A multi-carrier LTE system (described below) is one system fulfilling these requirements. A multi-carrier LTE system (described below) is one system fulfilling these requirements. Furthermore, the ability to utilize an aggregation of noncontiguous as well as contiguous bands of the radiofrequency spectrum makes it possible for communication system operators to adapt which parts of the radio spectrum will be used based on present circumstances and geographical position, thereby making such a solution very flexible.

Current cellular systems, such as LTE, utilize only contiguous allocations of spectral frequencies to users, but they are flexible in that these allocations can be of different bandwidths. This allows the radio frequency to be used efficiently: users with low throughput/quality of service requirements can be allocated a narrower bandwidth of spectrum than those with greater needs. A straightforward evolution of these types of current cellular systems that would add support for aggregating contiguous and non-contiguous spectrum as described above is to introduce multi-carrier operation. What this would mean is that each allocated spectrum “chunk” would correspond to an allocation of frequencies that one would encounter in an LTE system conforming to the 3GPP release 8 standard. A “4G” mobile terminal would then be capable of receiving a plurality of such LTE carriers (possibly of different bandwidths) transmitted at different carrier frequencies. FIG. 3 illustrates one such exemplary system. A serving node 301 serves a UE 303 that is located within the serving node's cell 305. The serving node 301 allocates one chunk of spectrum for use by the UE 303. A second node 307 serves a cell 309 in which the UE 303 is located, and allocates another chunk of spectrum for use by the UE 303. A third node 311 serves a cell 313 in which the UE 303 is located, and allocates yet another chunk of spectrum for use by the UE 303. It is stressed that this is just one of many possible exemplary embodiments. For example, one, several, or all of the serving nodes can be placed at the same physical location.

In many multi-carrier systems based on single-carrier systems, including the one being proposed to extend the capabilities of the LTE system, multi-carrier operation is set up using communication on only one of the carriers in a single-carrier mode. This carrier is often referred to as an anchor carrier, or alternatively as a primary component carrier. Other carriers used in multi-carrier operation are referred to as secondary carriers or secondary component carriers. Once multi-carrier operation has been established, the assignment of which carrier is playing the role of the primary component carrier may change.

One important aspect of cellular communication is to keep the uplink and downlink signals synchronized with one another between the eNB and the user equipment. In LTE systems, signal modulation is based on Orthogonal

Frequency Division Multiplexing (OFDM). In order to maintain orthogonality between users' signals in the uplink direction, there is a need for so-called timing advance commands to be sent from the network node to the user equipment. Each timing advance command tells its recipient user equipment at what moment it should begin transmitting its signals to the eNB (e.g., this can be expressed as a timing offset from a reference timing system). The need for timing advance commands arises because different user equipments are, in general, distanced from the eNB by different amounts. With the propagation delay of a user equipment's signal to the eNB depending on the distance from the eNB to the user equipment, the user equipments generally need to transmit their data at respectively different points in time in order for their transmitted signals to be synchronized with one another at the moment that they arrive at the eNB receiver. (Synchronization of these signals is required in order to enable coherent Fast Fourier Transform (FFT) processing by the eNB's receiver.)

The appropriate timing advance for each terminal is estimated by the eNB and timing advance commands are communicated in the downlink signaling to the user equipment, which then can adapt its timing accordingly. A conventional timing advance procedure supporting only single uplink and downlink carriers between the user equipment and the eNB is specified in Release 8 of the specification for LTE systems. In conventional systems (e.g., LTE Rel. 8, referenced above), the timing advance for the uplink is defined based on the timing of the single reference cell, transmitting on the single downlink carrier that the user equipment is connected to. Operation of a user equipment in a multi-carrier system, however, presents new technical issues that need to be resolved. Hence, there is a need for methods and apparatuses for a timing advance feature in multi-carrier systems.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

In accordance with one aspect of the present invention, the foregoing and other objects are achieved in methods, apparatuses, and computer readable storage mediums for operating a user equipment in a multi-carrier communication system, the user equipment comprising a transmitter and a receiver. Such operation comprises operating the receiver to concurrently receive at least two downlink carriers, and receiving, from one or more remote nodes of the multi-carrier communication system, one or more timing advance commands, each of the one or more timing advance commands being associated with a respective one of one or more groups of uplink carriers, each of the groups of uplink carriers comprising at least one uplink component carrier, and each of the groups of uplink carriers being associated with one or more of the received downlink carriers. For each of the one or more downlink carriers that are associated with one of the one or more groups of one or more uplink carriers, the following is performed:

selecting one of the one or more downlink carriers for use as a reference downlink carrier;

ascertaining a timing of the reference downlink carrier; and

ascertaining a transmission time period based on said ascertained timing of said downlink reference carrier and an offset specified by the timing advance command associated with the one of the one or more groups of one or more uplink carriers, wherein the transmission time period comprises a transmission start time and a transmission stop time.

The transmitter is then controlled to initiate transmission of information on the one or more groups of one or more uplink carriers at an earliest transmission start time of the ascertained transmission time periods and to cease transmission at a latest transmission stop time of the ascertained transmission time periods.

Many alternative embodiments are possible. For example:

In some embodiments, there is only one group of uplink carriers, and receiving, from the one or more remote nodes of the multi-carrier communication system, one or more timing advance commands comprises receiving only one timing advance command. In some of these alternatives, selecting one of the one or more downlink carriers for use as the reference downlink carrier comprises selecting from the at least two downlink carriers a downlink carrier on which the one timing advance command was received.

In some embodiments, the transmitter comprises only one power amplifier, and controlling the transmitter to initiate transmission of information on the one or more groups of one or more uplink carriers at the earliest transmission start time of the ascertained transmission time periods and to cease transmission at the latest transmission stop time of the ascertained transmission time periods comprises turning on the one power amplifier at the earliest transmission start time of the ascertained transmission time periods and turning off the one power amplifier at the latest transmission stop time of the ascertained transmission time periods.

In some embodiments, selecting one of the one or more downlink carriers for use as the reference downlink carrier comprises selecting a primary/anchor downlink carrier of a cell belonging to an active set.

In some embodiments, selecting one of the one or more downlink carriers for use as the reference downlink carrier comprises selecting a primary/anchor downlink carrier of a cell that is acting as a serving cell for the user equipment.

In some embodiments, selecting one of the one or more downlink carriers for use as the reference downlink carrier comprises ascertaining a level of synchronization reliability of the at least two downlink carriers. Then, a downlink carrier is selected from the at least two downlink carriers based on which one of the carriers has a highest level of synchronization reliability.

In some embodiments, selecting one of the one or more downlink carriers for use as the reference downlink carrier comprises selecting from the at least two downlink carriers a downlink carrier having a first detected downlink path.

In some embodiments, selecting one of the one or more downlink carriers for use as the reference downlink carrier comprises selecting from the at least two downlink carriers a downlink carrier on which the one timing advance command was received.

In some embodiments, selecting one of the one or more downlink carriers for use as the reference downlink carrier comprises selecting from the at least two downlink carriers a downlink carrier that was used by the user equipment for connection setup.

In some embodiments, the multi-carrier communication system is a Multi-Carrier Long Term Evolution (MC LTE) system as defined by the 3GPP.

In some embodiments, the multi-carrier communication system comprises a first system that is a Multi-Carrier Long Term Evolution (MC LTE) system as defined by the Third Generation Partnership Project (3GPP) and at least a second system that is not an MC LTE system as defined by the 3GPP.

### BRIEF DESCRIPTION OF THE DRAWINGS

The objects and advantages of the invention will be understood by reading the following detailed description in conjunction with the drawings in which:

FIG. 1 is a diagram illustrating a common feature found in most systems: a serving node serving a user equipment that is located within the serving node's geographical area of service, called a “cell”.

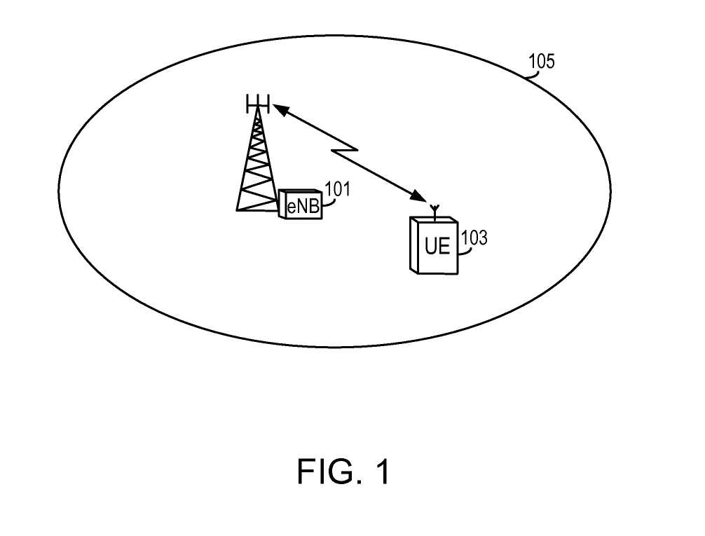

FIG. 2 shows an aggregation of contiguous and non-contiguous portions of radiofrequency spectrum.

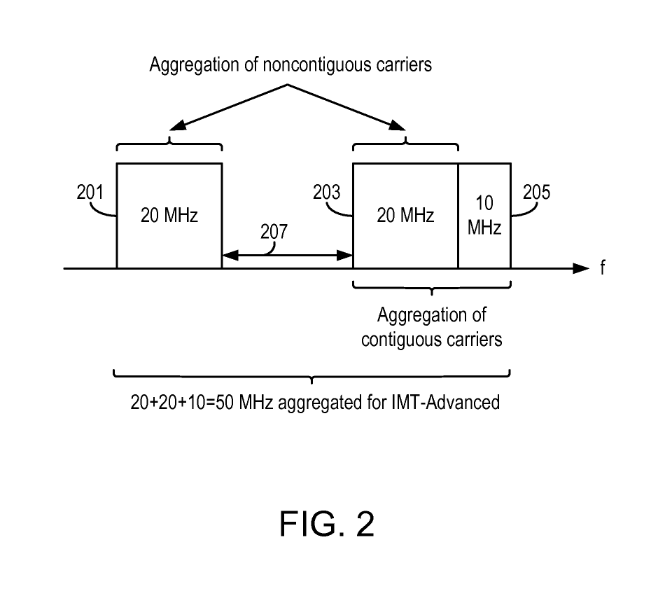

FIG. 3 is a diagram of a system in which multiple nodes concurrently allocate different chunks of radio spectrum for use by a UE.

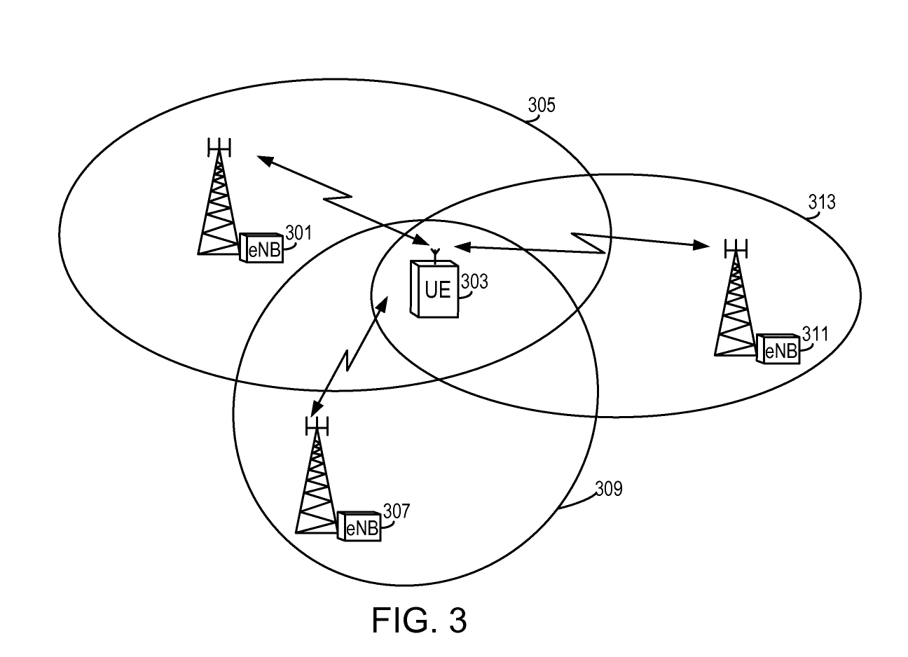

FIG. 4 is, in one respect, a flow diagram of steps/processes carried out in accordance with some embodiments consistent with the invention.

FIG. 5 is a block diagram of an exemplary user equipment comprising circuitry for carrying out functionality as illustrated or equivalent to that depicted in FIG. 4.

FIG. 6 is, in one respect, a flow diagram of steps/processes carried out in accordance with alternative embodiments involving a plurality of timing advance commands and being consistent with the invention.

FIG. 7 is a block diagram of an exemplary user equipment comprising circuitry for carrying out functionality as illustrated or equivalent to that depicted in FIG. 6.

### DETAILED DESCRIPTION

The various features of the invention will now be described with reference to the figures, in which like parts are identified with the same reference characters.

The various aspects of the invention will now be described in greater detail in connection with a number of exemplary embodiments. To facilitate an understanding of the invention, many aspects of the invention are described in terms of sequences of actions to be performed by elements of a computer system or other hardware capable of executing programmed instructions. It will be recognized that in each of the embodiments, the various actions could be performed by specialized circuits (e.g., analog and/or discrete logic gates interconnected to perform a specialized function), by one or more processors programmed with a suitable set of instructions, or by a combination of both. The term “circuitry configured to” perform one or more described actions is used herein to refer to any such embodiment (i.e., one or more specialized circuits and/or one or more programmed processors). Moreover, the invention can additionally be considered to be embodied entirely within any form of computer readable carrier, such as solid-state memory, magnetic disk, or optical disk containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiments as described above may be referred to herein as “logic configured to” perform a described action, or alternatively as “logic that” performs a described action.

As a convenience to the reader, the following description is presented using terminology from, and in the context of, multi-carrier operation in LTE systems. This helps facilitate the reader's understanding of the various aspects of embodiments consistent with the invention because it eliminates the need to describe aspects of multi-carrier systems that are already well-known to those of ordinary skill in the art. However, this approach to describing the invention is not intended to limit its application to only LTE systems. To the contrary, those of ordinary skill in the art will readily understand how to apply the various aspects of embodiments consistent with the invention in systems built in accordance with other radio access technologies, or in multi-carrier operation using a combination of different radio access technologies.

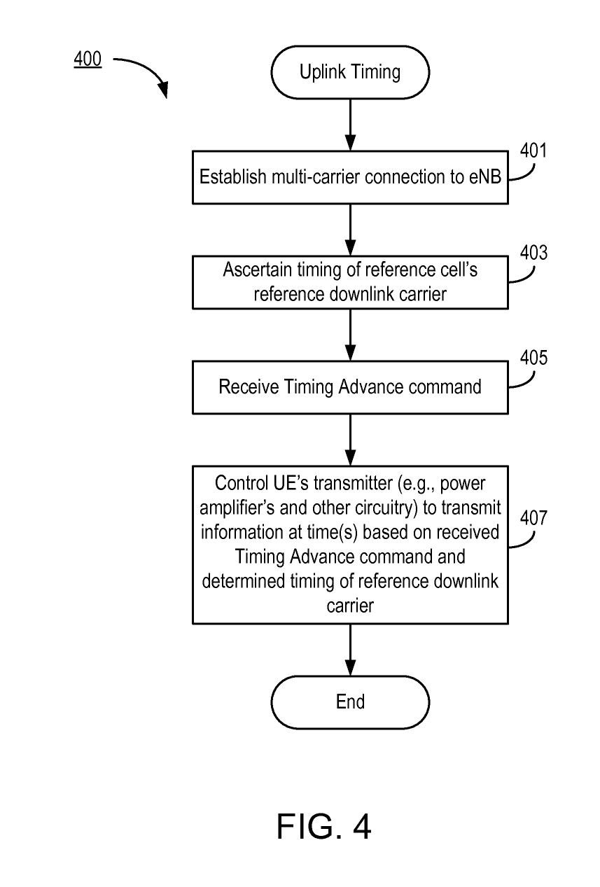

In a first exemplary embodiment, a user equipment comprising a transceiver including a transmitter and a receiver is employed in a multi-carrier LTE system that is communicating with the user equipment via at least two downlink carriers and at least one uplink carrier. In this exemplary embodiment, it is assumed that the user equipment receives only a single timing advance command that is applicable to all of the uplink carriers. This exemplary embodiment is illustrated in FIG. 4 which is, in one respect, a flow diagram of steps/processes carried out in accordance with embodiments consistent with the invention. FIG. 4 can alternatively be construed as a block diagram of a user equipment 400 comprising the variously illustrated means for carrying out aspects of these embodiments.

The user equipment 400 establishes a connection to a multi-component carrier system, such as a multi-carrier LTE system (e.g., connection to an eNB) or a dual cell HSPA system (step 401). This means that the user equipment is connected to a serving cell on one primary component downlink carrier, and to at least one other cell on at least one secondary component downlink carrier.

The user equipment 400 determines the timing of a reference downlink carrier transmitted by a reference cell (step 403). The reference cell could be any of the following:

a cell associated with a primary or anchor downlink carrier

a cell associated with a primary or secondary carrier based on a list that prioritizes lists based on how reliable the cells' downlink synchronization properties are

a cell on the downlink carrier having the first detected downlink path

if there is only one uplink carrier, the downlink carrier of the cell associated with the only uplink carrier

a cell associated with downlink carrier from which the timing advance command was received

the cell and the reference carrier that the user equipment (transceiver) was using for connection setup of the current connection.

In communication systems supporting soft handover, such as a Wideband Code Divisional Multiple Access (WCDMA) system the reference cell could be any cell transmitting on the reference downlink carrier, such as:

the cell acting as serving cell for the particular terminal

the cell in the active set that first was used as a serving cell for the terminal.

(It is well known in the art that an “active set” is, in the context of a WCDMA system, the cells that a UE listens to and decodes information from in case of a soft handover.)

The timing is typically defined as the first reliable detected path from the reference cell on the reference downlink carrier, and it is typically determined by correlating the received signal to a known signal, like a synchronization or pilot signal (in LTE systems, a primary synchronization or secondary synchronization signal, or the reference signals).

The user equipment then receives the timing advance command from a network node (e.g., eNB) (step 405). Then, based on the downlink timing ascertained from the reference downlink carrier of the reference cell and also on the timing advance command, the transmit timing (e.g., start/stop timing of the transmitter's power amplifier and/or other transmitter related parts of a radio chip) is adjusted, and the information to be transmitted is adjusted according to the timing determination (step 407).

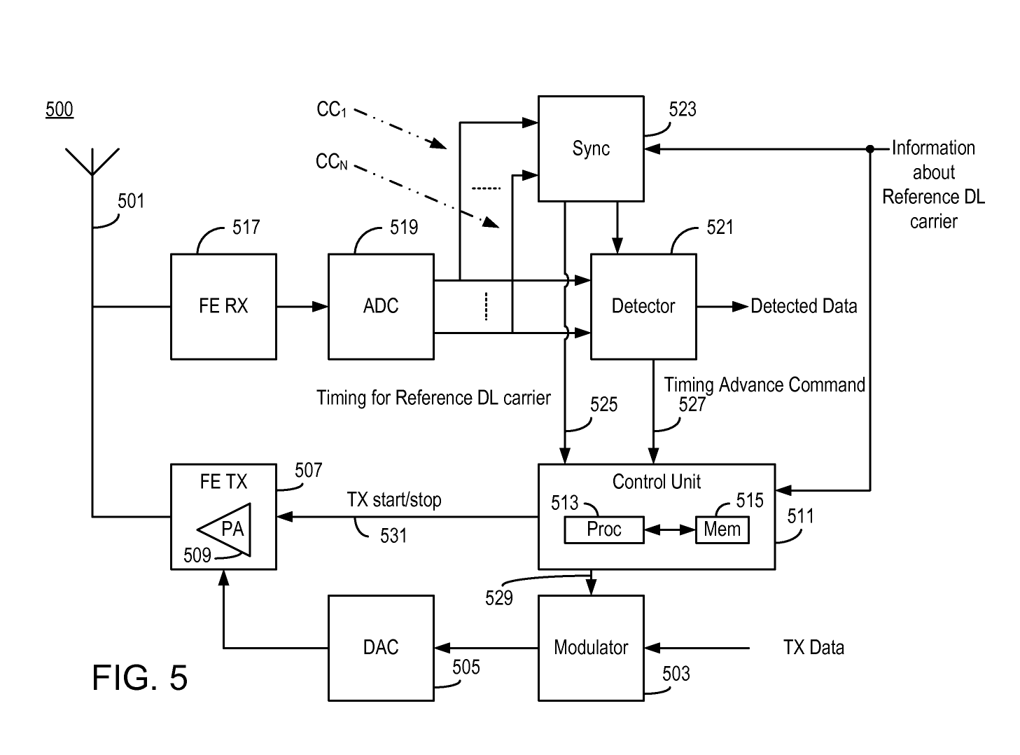

FIG. 5 is a block diagram of an exemplary user equipment 500 comprising circuitry for carrying out functionality as illustrated or equivalent to that depicted in FIG. 4. To facilitate the reader's comprehension of the various aspects in accordance with inventive embodiments, only that circuitry having relevance to the invention is shown. Those of ordinary skill in the art will recognize that other well known circuitry associated with user equipment is also included.

Radiofrequency signals are received by and transmitted from an antenna 501. In this exemplary embodiment, a single antenna that is shared for both reception and transmission is illustrated. In alternative embodiments, multiple antennas may be employed for transmission and/or reception, and the receiver and transmitter may or may not share one or more of these antennas.

For transmitting data, the user equipment 500 includes a modulator 503 that modulates supplied digital data to be transmitted. The modulated data is converted to analog form by a digital-to-analog converter (DAC) 505. The resulting analog signal is supplied to front-end transmitter circuitry (FE TX) 507 which includes, for example, a power amplifier (PA) 509.

The modulator 503 as well as the front-end transmitter circuitry 507 are controlled by a control unit 511. The control unit 511 generates control signals that cause the various circuitry of the user equipment 500 to carry out functions such as those described above with respect to FIG. 4. The control unit 511 can be embodied in any of a number of different forms, no one of which is essential. For example, hardwired logic circuitry can be used. Alternatively, a programmable processor 513 can be programmed with a suitable set of program instructions (e.g., stored in a memory 515) to carry out the desired functionality as described herein. Those of ordinary skill in the art will also recognize that the control unit 511 can be embodied as a mixture of hardwired logic circuitry with a suitably programmed processor 513.

Turning now to the receiver side, radiofrequency signals picked up by the antenna 501 are supplied to front-end receiver (FE RX) circuitry 517. The signals on the desired carrier(s) are down converted to analog baseband signals and then converted into digital form by an analog-to-digital converter (ADC) 519.

As the user equipment 400 is operating in a multi-carrier system, a plurality (1 . . . N) of component carriers CC₁ . . . CC_{N} are supplied in digital form at the output of the ADC 519. These are provided to a detector 521 and to synchronization circuitry 523.

The synchronization circuitry 523 determines the timing of each of the component carriers CC₁ . . . CC_{N}, and supplies this timing information to the detector 521 which is thereby enabled to detect the data carried on each of the component carriers. Detection is performed in any of a number of known ways and therefore need not be described here in greater detail. This detected data is supplied at one or more output ports of the detector 521.

The synchronization circuitry 523 also receives information about the downlink reference carrier that enables it to know which of the component carriers CC₁ . . . CC_{N} is the reference downlink carrier. The determination of the reference cell(s)/carrier is performed by a higher layer decoding unit (not shown) and is based on detected data that has been forwarded to higher layer processing circuitry. This enables the synchronization circuitry 523 to supply the timing for the reference downlink carrier 525 to the control unit 511. Furthermore, the detector 521 includes circuitry that extracts the timing advance command from the eNB's downlink signaling and supplies the timing advance command 527 to the control unit 511.

The control unit 511 then uses the timing for the reference downlink carrier and the timing advance command to ascertain when data transmissions should take place. Based on this ascertainment, the control unit 511 generates control signals (e.g., modulator control signals 529 and transmission start/stop control signals 531 (e.g., which turn the power amplifier(s) on and off) which are supplied to the circuitry being controlled.

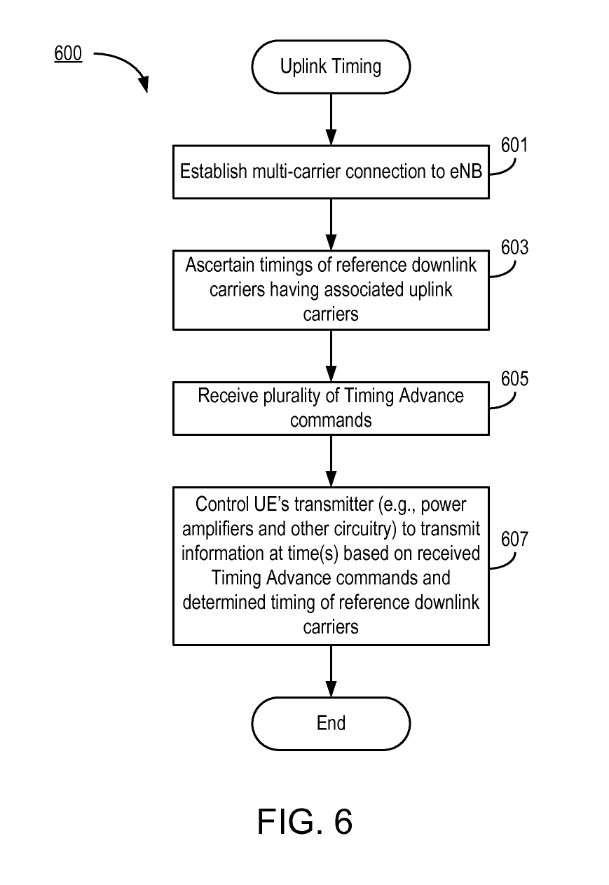

In a second exemplary embodiment, a user equipment comprising a transceiver including a transmitter and a receiver is employed in a multi-carrier LTE system that is communicating with the user equipment via at least two downlink carriers and at least one uplink carrier. In this exemplary embodiment, it is assumed that the user equipment receives a plurality of timing advance commands, each being valid for a respective subset of a plurality of uplink component carriers. In this way, each of the timing advance commands is associated with the timing of a respective one of a plurality of reference cells, analogously to the single reference cell providing the single timing advance command in embodiments such as those illustrated by FIGS. 4 and 5. This exemplary embodiment is illustrated in FIG. 6 which is, in one respect, a flow diagram of steps/processes carried out in accordance with embodiments consistent with the invention. FIG. 6 can alternatively be construed as a block diagram of a user equipment 600 comprising the variously illustrated means for carrying out aspects of these embodiments.

The user equipment 600 establishes a connection to a multi-component carrier system, such as a multi-carrier LTE system (e.g., connection to an eNB) or a dual cell HSPA system (step 601). This means that the user equipment is connected to a serving cell on one primary component downlink carrier, and to at least one other cell on at least one secondary component downlink carrier.

The user equipment 600 determines the timing of each reference downlink carrier transmitted by a connected cell that has a related uplink component carrier (step 603). The association between uplink and downlink carriers can be hard coded in the specification (e.g., by means of a fixed duplex distance that applies to all UEs. Alternatively, the association between uplink and downlink carriers can change dynamically, and be obtained by higher layer signaling (e.g., as the message for downlink reference cell/carrier).

The timing is typically defined as the first reliable detected path from the reference cell on the reference downlink carrier, and it is typically determined by correlating the received signal to a known signal, like a synchronization or pilot signal (in LTE systems, a primary synchronization or secondary synchronization signal, or the reference signals).

The user equipment then receives the timing advance commands, each associated with a different group of one or more uplink carriers, from a network node (e.g., eNB) (step 605). The timing advance commands can all be received from a serving cell, or alternatively timing advance commands can be received for respective uplinks on respective associated downlink component carriers. In yet other alternatives, timing advance commands can be received according to a specific scheme defined by a communications standard or signaled from the network.

Then, based on the respective downlink timing ascertained from the reference downlink carriers (reference cells) and also on the associated timing advance commands, the transmit timing (e.g., start/stop timing of the transmitter's power amplifier and/or other transmitter related parts of a radio chip) is adjusted, and the information to be transmitted is adjusted according to the timing determination (step 607).

As an example, when there is just a single power amplifier used for transmitting all the uplink component carriers, the transmitter chain including the power amplifier is turned on at a time instant corresponding to the earliest downlink carrier timing plus the offset specified by the associated timing advance command, and the transmitter chain and power amplifier are turned off at a time corresponding to the latest downlink component carrier timing plus an offset specified by the associated timing advance command.

As yet another example, when there is a plurality of power amplifiers, each transmitting a respective subset of uplink channels, the respective transmitter chain including the power amplifier is turned on at a time instant corresponding to the respective earliest downlink component carrier timing plus an offset specified by the associated timing advance command, and the respective transmitter chain and power amplifier is turned off at a time corresponding to the respective latest downlink carrier timing plus an offset specified by the associated timing advance command.

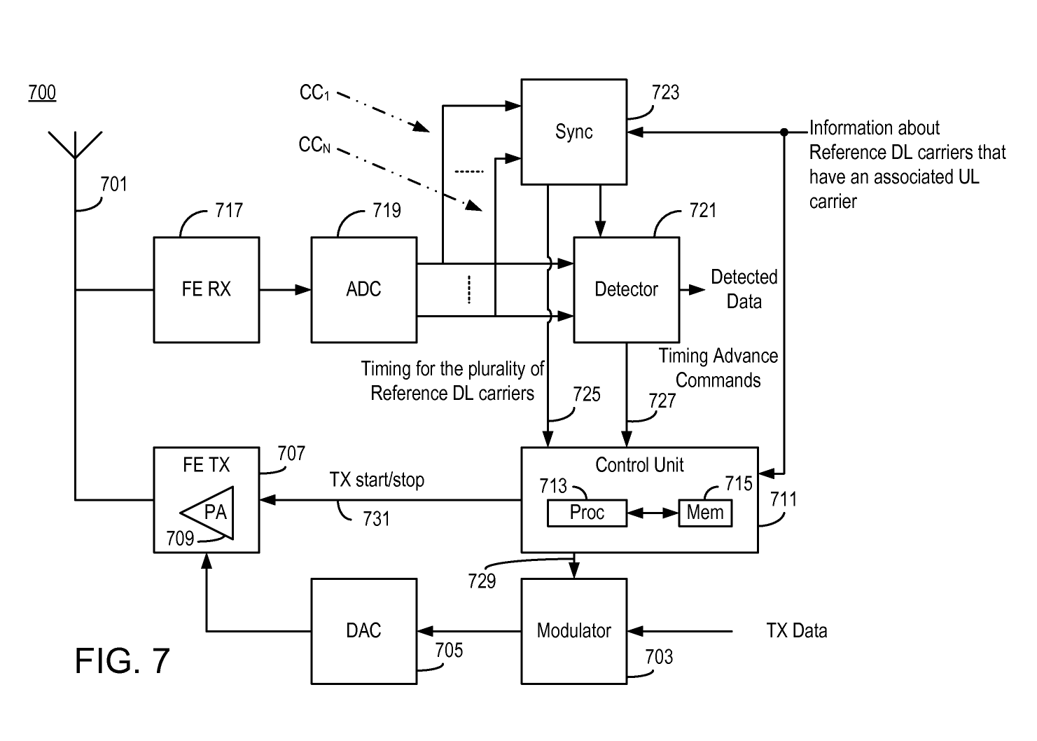

FIG. 7 is a block diagram of an exemplary user equipment 700 comprising circuitry for carrying out functionality as illustrated or equivalent to that depicted in FIG. 6. To facilitate the reader's comprehension of the various aspects in accordance with inventive embodiments, only that circuitry having relevance to the invention is shown. Those of ordinary skill in the art will recognize that other well known circuitry associated with user equipment is also included.

Radiofrequency signals are received by and transmitted from an antenna 701. In this exemplary embodiment, a single antenna that is shared for both reception and transmission is illustrated. In alternative embodiments, multiple antennas may be employed for transmission and/or reception, and the receiver and transmitter may or may not share one or more of these antennas.

For transmitting data, the user equipment 700 includes a modulator 703 that modulates supplied digital data to be transmitted. The modulated data is converted to analog form by a digital-to-analog converter (DAC) 705. The resulting analog signal is supplied to front-end transmitter circuitry (FE TX) 707 which includes, for example, a power amplifier (PA) 709.

The modulator 703 as well as the front-end transmitter circuitry 707 are controlled by a control unit 711. The control unit 711 generates control signals that cause the various circuitry of the user equipment 700 to carry out functions such as those described above with respect to FIG. 6. The control unit 711 can be embodied in any of a number of different forms, no one of which is essential. For example, hardwired logic circuitry can be used. Alternatively, a programmable processor 713 can be programmed with a suitable set of program instructions (e.g., stored in a memory 715) to carry out the desired functionality as described herein. Those of ordinary skill in the art will also recognize that the control unit 711 can be embodied as a mixture of hardwired logic circuitry with a suitably programmed processor 713.

Turning now to the receiver side, radiofrequency signals picked up by the antenna 701 are supplied to front-end receiver (FE RX) circuitry 717. The signals on the desired carrier(s) are down converted to analog baseband signals and then converted into digital form by an analog-to-digital converter (ADC) 719.

As the user equipment 700 is operating in a multi-carrier system, a plurality (1 . . . N) of component carriers CC₁ . . . CC_{N} are supplied in digital form at the output of the ADC 719. These are provided to a detector 721 and to synchronization circuitry 723.

The synchronization circuitry 723 determines the timing of each of the component carriers CC₁ . . . CC_{N}, and supplies this timing information to the detector 721 which is thereby enabled to detect the data carried on each of the component carriers. Detection is performed in any of a number of known ways and therefore need not be described here in greater detail. This detected data is supplied at one or more output ports of the detector 721.

The synchronization circuitry 723 also receives information about the downlink reference carriers having associated uplink carriers. This enables the synchronization circuitry 723 to know which of the component carriers CC₁ . . . CC_{N} will be used for ascertaining timing information, which in turn enables the synchronization circuitry 723 to supply the timing for the reference downlink carriers 725 to the control unit 711. The determination of the reference cell(s)/carrier having an associated uplink carrier is performed by a higher layer decoding unit (not shown) and is based on detected data that has been forwarded to higher layer processing circuitry. Furthermore, the detector 721 includes circuitry that extracts the timing advance commands associated with respective downlink carriers and supplies the timing advance commands 727 to the control unit 711.

The control unit 711 then uses each of the timings for the reference downlink carriers and the associated timing advance commands to ascertain when data transmissions should take place. Based on this ascertainment, the control unit 711 generates control signals (e.g., modulator control signals 729 and transmission start/stop control signals 731 (e.g., which turn the power amplifier(s) on and off) which are supplied to the circuitry being controlled.

Embodiments in accordance with aspects of the invention define the operation of timing advance in a multi-component carrier system. This makes it possible to keep the user equipment's uplink signals synchronized in multi-carrier systems.

The invention has been described with reference to particular embodiments. However, it will be readily apparent to those skilled in the art that it is possible to embody the invention in specific forms other than those of the embodiment described above.

For example, the above-described embodiments have been presented from the perspective of UE operation in a multi-carrier communication system that operates in accordance with one standard (e.g., a Multi-Carrier Long Term Evolution (MC LTE) system as defined by the Third Generation Partnership Project (3GPP)). However, this is not an essential aspect of the invention. In some alternative embodiments, the multi-carrier communication system in which the UE operates actually comprises a plurality of different systems, such as a first system that is a Multi-Carrier Long Term Evolution (MC LTE) system as defined by the 3GPP and at least a second system that is not an MC LTE system as defined by the 3GPP.

Thus, the described embodiments are merely illustrative and should not be considered restrictive in any way. The scope of the invention is given by the appended claims, rather than the preceding description, and all variations and equivalents which fall within the range of the claims are intended to be embraced therein.

What is claimed is:

1. A method of operating a user equipment in a multi-carrier communication system, the user equipment comprising a transmitter and a receiver, the method comprising:
operating the receiver to concurrently receive at least two downlink carriers;
receiving, from one or more remote nodes of the multi-carrier communication system, one or more timing advance commands, each of the one or more timing advance commands being associated with a respective one of one or more groups of uplink carriers, each of the groups of uplink carriers comprising at least one uplink component carrier, and each of the groups of uplink carriers being associated with one or more of the received downlink carriers;
for each of the one or more downlink carriers that are associated with one of the one or more groups of one or more uplink carriers, performing:
selecting one of the one or more downlink carriers for use as a reference downlink carrier;
ascertaining a timing of the reference downlink carrier; and
ascertaining a transmission time period based on said ascertained timing of said downlink reference carrier and an offset specified by the timing advance command associated with the one of the one or more groups of one or more uplink carriers, wherein the transmission time period comprises a transmission start time and a transmission stop time; and
controlling the transmitter to initiate transmission of information on the one or more groups of one or more uplink carriers at an earliest transmission start time of the ascertained transmission time periods and to cease transmission at a latest transmission stop time of the ascertained transmission time periods.

2. The method of claim 1, wherein there is only one group of uplink carriers, and receiving, from the one or more remote nodes of the multi-carrier communication system, one or more timing advance commands comprises receiving only one timing advance command.

3. The method of claim 2, wherein selecting one of the one or more downlink carriers for use as the reference downlink carrier comprises:
selecting from the at least two downlink carriers a downlink carrier on which the one timing advance command was received.

4. The method of claim 1, wherein the transmitter comprises only one power amplifier, and wherein controlling the transmitter to initiate transmission of information on the one or more groups of one or more uplink carriers at the earliest transmission start time of the ascertained transmission time periods and to cease transmission at the latest transmission stop time of the ascertained transmission time periods comprises:
turning on the one power amplifier at the earliest transmission start time of the ascertained transmission time periods and turning off the one power amplifier at the latest transmission stop time of the ascertained transmission time periods.

5. The method of claim 1, wherein selecting one of the one or more downlink carriers for use as the reference downlink carrier comprises:
selecting a primary/anchor downlink carrier of a cell belonging to an active set.

6. The method of claim 1, wherein selecting one of the one or more downlink carriers for use as the reference downlink carrier comprises:
selecting a primary/anchor downlink carrier of a cell that is acting as a serving cell for the user equipment.

7. The method of claim 1, wherein selecting one of the one or more downlink carriers for use as the reference downlink carrier comprises: ascertaining a level of synchronization reliability of the at least two downlink carriers; and
selecting from the at least two downlink carriers a downlink carrier having a highest level of synchronization reliability.

8. The method of claim 1, wherein selecting one of the one or more downlink carriers for use as the reference downlink carrier comprises:
selecting from the at least two downlink carriers a downlink carrier having a first detected downlink path.

9. The method of claim 1, wherein selecting one of the one or more downlink carriers for use as the reference downlink carrier comprises:
selecting from the at least two downlink carriers a downlink carrier on which the one timing advance command was received.

10. The method of claim 1, wherein selecting one of the one or more downlink carriers for use as the reference downlink carrier comprises:
selecting from the at least two downlink carriers a downlink carrier that was used by the user equipment for connection setup.

11. The method of claim 1, wherein the multi-carrier communication system is a Multi-Carrier Long Term Evolution (MC LTE) system as defined by the Third Generation Partnership Project (3GPP).

12. The method of claim 1, wherein the multi-carrier communication system comprises a first system that is a Multi-Carrier Long Term Evolution (MC LTE) system as defined by the Third Generation Partnership Project (3GPP) and at least a second system that is not an MC LTE system as defined by the 3GPP.

13. An apparatus for operating a user equipment in a multi-carrier communication system, the user equipment comprising a transmitter and a receiver, the apparatus comprising:
means for operating the receiver to concurrently receive at least two downlink carriers;
means for receiving, from one or more remote nodes of the multi-carrier communication system, one or more timing advance commands, each of the one or more timing advance commands being associated with a respective one of one or more groups of uplink carriers, each of the groups of uplink carriers comprising at least one uplink component carrier, and each of the groups of uplink carriers being associated with one or more of the received downlink carriers;
means for performing, for each of the one or more downlink carriers that are associated with one of the one or more groups of one or more uplink carriers, the following:
selecting one of the one or more downlink carriers for use as a reference downlink carrier;
ascertaining a timing of the reference downlink carrier; and
ascertaining a transmission time period based on said ascertained timing of said downlink reference carrier and an offset specified by the timing advance command associated with the one of the one or more groups of one or more uplink carriers, wherein the transmission time period comprises a transmission start time and a transmission stop time; and
means for controlling the transmitter to initiate transmission of information on the one or more groups of one or more uplink carriers at an earliest transmission start time of the ascertained transmission time periods and to cease transmission at a latest transmission stop time of the ascertained transmission time periods.

14. The apparatus of claim 13, wherein there is only one group of uplink carriers, and the means for receiving, from the one or more remote nodes of the multi-carrier communication system, one or more timing advance commands comprises means for receiving only one timing advance command.

15. The apparatus of claim 14, wherein the means for selecting one of the one or more downlink carriers for use as the reference downlink carrier comprises:
means for selecting from the at least two downlink carriers a downlink carrier on which the one timing advance command was received.

16. The apparatus of claim 13, wherein the transmitter comprises only one power amplifier, and wherein the means for controlling the transmitter to initiate transmission of information on the one or more groups of one or more uplink carriers at the earliest transmission start time of the ascertained transmission time periods and to cease transmission at the latest transmission stop time of the ascertained transmission time periods comprises:
means for turning on the one power amplifier at the earliest transmission start time of the ascertained transmission time periods and turning off the one power amplifier at the latest transmission stop time of the ascertained transmission time periods.

17. The apparatus of claim 13, wherein the means for selecting one of the one or more downlink carriers for use as the reference downlink carrier comprises:
means for selecting a primary/anchor downlink carrier of a cell belonging to an active set.

18. The apparatus of claim 13, wherein the means for selecting one of the one or more downlink carriers for use as the reference downlink carrier comprises:
means for selecting a primary/anchor downlink carrier of a cell that is acting as a serving cell for the user equipment.

19. The apparatus of claim 13, wherein the means for selecting one of the one or more downlink carriers for use as the reference downlink carrier comprises:
means for ascertaining a level of synchronization reliability of the at least two downlink carriers; and
means for selecting from the at least two downlink carriers a downlink carrier having a highest level of synchronization reliability.

20. The apparatus of claim 13, wherein the means for selecting one of the one or more downlink carriers for use as the reference downlink carrier comprises:
means for selecting from the at least two downlink carriers a downlink carrier having a first detected downlink path.

21. The apparatus of claim 13, wherein the means for selecting one of the one or more downlink carriers for use as the reference downlink carrier comprises:
means for selecting from the at least two downlink carriers a downlink carrier on which the one timing advance command was received.

22. The apparatus of claim 13, wherein the means for selecting one of the one or more downlink carriers for use as the reference downlink carrier comprises:
means for selecting from the at least two downlink carriers a downlink carrier that was used by the user equipment for connection setup.

23. The apparatus of claim 13, wherein the multi-carrier communication system is a Multi-Carrier Long Term Evolution (MC LTE) system as defined by the Third Generation Partnership Project (3GPP).

24. The apparatus of claim 13, wherein the multi-carrier communication system comprises a first system that is a Multi-Carrier Long Term Evolution (MC LTE) system as defined by the Third Generation Partnership Project (3GPP) and at least a second system that is not an MC LTE system as defined by the 3GPP.
